(19) United States
(12) Patent Application Publication
(10) Pub. No.: US 2024/0167447 A1
(43) Pub. Date: May 23, 2024

(54) HELICALLY SHAPED WING AND HYDRAULIC MICROPOWER GENERATOR

(71) Applicant: Akira SAITO, Tokyo (JP)

(72) Inventor: Akira SAITO, Kanagawa (JP)

(21) Appl. No.: 18/281,572

(22) PCT Filed: Mar. 10, 2022
(86) PCT No.: PCT/JP2022/010748

§ 371 Date: Sep. 12, 2023

(30) Foreign Application Priority Data
Mar. 15, 2021 (JP) 2021-041463

(51) Int. Cl. F03B 3/12

(52) U.S. Cl. CPC F03B 3/121; F05B 2250/25

(57) ABSTRACT

Provided is a helically shaped wing including a column-shaped shaft portion and a blade portion disposed helically on a side surface of the shaft portion. The blade portion includes a winglet on an end portion thereof.

### TECHNICAL FIELD

The present disclosure relates to a helically shaped wing and a hydraulic micropower generator.

### BACKGROUND ART

In recent years, hydraulic micropower generation for outputting power of 100 kW or lower has been becoming popular in European countries and emerging countries such as Asian countries from the viewpoints of environment and effective utilization of renewable energy. However, no systems that satisfy maintainability and costs have been provided yet. As one factor, there is a problem that each hydraulic micropower generator needs custom design suited to, for example, the shape, size, and water volume of each waterway, and parts costs run up as a result

In general, a rotating body configured to convert a water current to a rotational power has a higher efficiency in converting a water current to a rotational power as the rotating body is more perpendicular to the direction of the water current and receives resistance from the water current over a larger surface thereof. On the other hand, it is assumed that the hydraulic micropower generator described above will be used being installed in a narrow flow path or at a place having a small hydraulic head. In this case, a large-sized rotating body cannot be used.

### SUMMARY OF INVENTION

### Technical Problem

A helical wing is a rotating body that can be installed in a narrow flow path. However, a helical wing has a problem that it cannot generate power efficiently because of its poor conversion efficiency compared with a water turbine or a propeller-shaped rotating body.

### Solution to Problem

According to one aspect of the present disclosure, a helically shaped wing includes a column-shaped shaft portion, a blade portion disposed helically on a side surface of the shaft portion, and a winglet on an end portion of the blade portion.

### Advantageous Effects of Invention

The present disclosure can provide a helically shaped wing that can convert a water current to a rotational power more efficiently than ever. This also makes it possible to provide a hydraulic micropower generator that can generate power efficiently even when installed in a narrow flow path having a water current of a low volume or in a waterway having a small hydraulic head.

### BRIEF DESCRIPTION OF DRAWINGS

FIG. 1 is an exemplary view of a helically shaped wing No. 4 in Example 1.

FIG. 2A is a partial expanded view illustrating a winglet shape 1 in Example 1.

FIG. 2B is a partial expanded view illustrating a winglet shape 2.

### DESCRIPTION OF EMBODIMENTS

<1> Helically Shaped Wing

According to an aspect of the present disclosure, a helically shaped wing is provided. In the present disclosure, a “helically shaped wing” means a rotating body including a blade disposed helically on a side surface of a column-shaped structure. The helically shaped wing may also be referred to as, for example, a helically shaped water turbine when the helically shaped wing is used as a rotating body configured to convert a water current to a rotational power. The helically shaped wing can convert a fluid pressure (for example, a water current or a wind power) parallel with the direction of the longer axis of the column-shaped structure to a rotational power about the longer axis of the column-shaped structure. In the present disclosure, such a column-shaped structure is referred to as a “shaft portion” of the helically shaped wing, and the blade disposed helically is referred to as “blade portion”

In an embodiment, the helically shaped wing of the present disclosure includes a winglet on an end portion of the blade portion. In the present disclosure, a “winglet” is a small feather-shaped structure provided on an end portion of the blade portion. The winglet can prevent a fluid pressure from escaping along the helically shaped blade portion, making it possible to efficiently convert a fluid pressure to a rotational power. The size of the winglet is not particularly limited. However, an extremely small winglet cannot prevent a fluid pressure from escaping, and an extremely large winglet disturbs a fluid flow. Hence, as a preferable ratio between the width of the winglet and the width of the blade portion, the width of the blade portion is designed to be from five times through a hundred times greater than the width of the winglet.

The winglet is provided on an end portion of the blade portion at a predetermined angle with respect to the blade portion. Such an angle is referred to as an inclination angle of the winglet with respect to the blade portion. When the inclination angle is extremely small, it is impossible to prevent a fluid pressure from escaping. When the inclination angle is extremely large, a fluid flow is likely to be disturbed. The preferable inclination angle is from 5 degrees through 80 degrees, more preferably from 10 degrees through 50 degrees, and yet more preferably from 10 degrees through 30 degrees.

The shape of the winglet is not particularly limited. The winglet may be formed with a thickness that is the same as or similar to the blade portion, and may be formed in a thinner shape than the blade portion. The number of winglets present on the end portion is not particularly limited, and a plurality of winglets may be present on the end portion of the blade portion. For example, the end portion of the blade portion may have a bifurcated shape. In this case, two winglets are supposed to be present on the end portion of the blade portion. Preferably, one or two winglets are present on the end portion.

When two winglets are present on the end portion, the winglets may have the same inclination angle or different inclination angles. Preferably, the inclination angle of one winglet is from one time through eight times, particularly preferably from one time through three times greater than the inclination angle of another winglet.

The winglet may be attached and installed on the blade portion, or may be formed integrally with the blade portion. In a preferred embodiment, the winglet is formed integrally with the blade portion using the same material as the blade portion.

In another embodiment of the present disclosure, the shaft portion or the blade portion, or both have a riblet structure. In the present disclosure, a “riblet structure” means a cyclically, minutely recessed and bumped structure intended to reduce fluid friction. Examples of a naturally occurring riblet structure include a structure of scales of a fish such as a shark. A cyclically recessed and bumped structure mimicking the natural riblet structure is known to be able to reduce fluid friction.

The riblet structure is intended to reduce fluid friction. Hence, the helically shaped wing of the present disclosure having the riblet structure can reduce power loss due to friction. The riblet structure that can be employed for the helically shaped wing of the present disclosure is not particularly limited, and various structures known as riblet structures can be employed. Representative examples of the riblet structure include a recessed and bumped shape including recesses and bumps continuous in a predetermined pattern, a shape including U-shaped or V-shaped groove structures repeating cyclically, and repeating shapes such as a square wave and a sinusoidal wave. Such groove structures as described above may be segmented with crescent or circular structures to add another set of scale-like repeating shapes to the riblet structure.

The difference between the maximum height and minimum height of the recessed and bumped shape is preferably from 50 micrometers through 2 mm and more preferably from 100 micrometers through 500 micrometers.

In a preferred embodiment of the helically shaped wing of the present disclosure, the helically shaped wing includes both of the winglet and the riblet structure.

Any column-shaped structure can be used as the shaft portion of the helically shaped wing of the present disclosure. Typically, the shaft portion has a cylindrical shape. The helically shaped wing is configured to rotate when a fluid flows along the direction of the longer axis of the cylinder and thrusts the blade portion.

The blade portion of the helically shaped wing of the present disclosure is formed as a plate-shaped structure that is wound helically on the circumference (side surface) of the shaft portion. The blade portion may be formed at a constant helical angle, or a part of the blade portion may be formed to have a different helical angle. For example, the helical angle of the blade portion may be designed to increase halfway by a predetermined amount (i.e., the blade may be inclined more gently). This makes it possible to suppress the fluid pressure that is to be applied to the blade portion near the exit of the helically shaped wing. Moreover, by rounding the corner of the edge portion of the blade portion, it is possible to further suppress the resistance. These factors add to more efficient power conversion.

The material of the helically shaped wing of the present disclosure is not particularly limited so long as a sufficient strength is ensured. Metals may be used as the material of the helically shaped wing. However, resins are suitably used considering the balance between strength and weight, and shapability. Examples of the resins include thermoplastic resins, photo-curable resins, and these resins coated with hard materials such as metals or silica.

The thermoplastic resin is not particularly limited and may be appropriately selected depending on the intended purpose so long as the thermoplastic resin has a cured state in the environment in which the helically shaped wing is used. Examples of such a thermoplastic resin include, but are not limited to, polyamide 12 (PA12), polyamide 11 (PA11), polybutylene terephthalate, polypropylene, polyamide 9T (PA9T), polyamide 10T (PA10T), thermoplastic polyurethane (TPU), and thermoplastic elastomer (TPE). One of these thermoplastic resins may be used alone or two or more of these thermoplastic resins may be used in combination.

Using a thermoplastic resin composition containing the thermoplastic resin, the helically shaped wing can be produced by, for example, a high speed sintering (HSS) method and a selective laser sintering (SLS) method.

The photo-curable resin is not particularly limited and may be appropriately selected depending on the intended purpose so long as the photo-curable resin has a sufficient hardness in a cured state. Examples of such a photo-curable resin include, but are not limited to, phenol resins, unsaturated polyester resins, polyimide resins, epoxy resins, urethane resins, alkyd resins, diallyl phthalate resins, acrylic resins, and methacrylic resins, or mixtures or copolymers of these photo-curable resins.

Using a curable composition containing a precursor of the photo-curable resin and a polymerization initiator, the helically shaped wing can be produced by, for example, a stereolithography (SLA) method.

The curable composition is suitably used in the stereolithography (SLA) method, but can be used in other methods than stereolithography. For example, use of the curable composition in an inkjet method is assumable, but there is a need for looking into a discharging mechanism that can accommodate to the viscosity of the curable composition and the fiber diameter of nanofiber.

By coating the thermoplastic resin or the photo-curable resin with a metal or silica, it is possible to increase strength. The thickness of a metal or silica coating film may be, for example, 1 micrometer or greater but 200 micrometers or less and preferably 20 micrometers or greater but 200 micrometers or less. When the thickness of a metal or silica film is 1 micrometer or greater but 200 micrometers or less, a helically shaped wing having an excellent durability can be obtained.

Examples of the metal coating method include a dipping method using a metal coating liquid, and an electroplating method. Hence, the metal used for coating is not particularly limited so long as the metal can be used in these methods. Examples of the metal include silver, gold, platinum, copper, zinc, cobalt, nickel, and iron, or alloys of these metals. Examples of silica coating include a dipping method using a silica coating liquid.

The photo-curable resin may further contain nanofiber. Using a photo-curable resin encapsulating the nanofiber, it is possible to better improve heat resistance and strength. The nanofiber is formed of, for example, ceramics, glass, cellulose, alumina, titania, carbon, and siloxane. One of these materials may be used alone or two or more of these materials may be used in combination. In terms of improving strength and heat resistance, examples of the material other than the materials described above include nanofiber descried in International Publication No. WO 2008/057844.

The shape of the nanofiber is not particularly limited and may be appropriately changed as needed. The fiber diameter of the nanofiber is preferably 1 micrometer or greater but 30 micrometers or less, more preferably 2 micrometers or greater but 25 micrometers or less, and yet more preferably 4 micrometers or greater but 15 micrometers or less.

The fiber length of the nanofiber is preferably 50 micrometers or greater, more preferably 100 micrometers or greater, and yet more preferably 300 micrometers or greater. The upper limit of the fiber length of the nanofiber is not particularly limited, may be appropriately selected depending on the intended purpose, and is preferably 3,000 micrometers or less.

When the fiber diameter and the fiber length of the nanofiber are in the numerical ranges described above, heat resistance and strength of the helically shaped wing can be better improved, and the helically shaped wing can be formed with a surface roughness that is the same as or similar to the surface roughness of a cured product obtained when no nanofiber is added.

The fiber diameter and the fiber length of the nanofiber represent average values. The helically shaped wing is measured with a scanning electron microscope (SEM) at five points, and the average of the measurements is calculated.

In terms of improving adhesiveness between the nanofiber and the resin component, a sizing agent may be added or surface treatment may be applied to the nanofiber. Of these options, it is preferable to use nanofiber of which surface is hydrophobized.

The hydrophobizing agent used in the hydrophobizing treatment is not particularly limited and may be appropriately selected depending on the intended purpose. Examples of the hydrophobizing agent include silane coupling agents such as hexamethyl disilazane (HMDS) and dimethyl dicyclosilane (DMDS), and silicone oils such as dimethyl silicone oil and amino-modified silicone oils. One of these hydrophobizing agents may be used alone or two or more of these hydrophobizing agents may be used in combination. Among these hydrophobizing agents, silane coupling agents are preferable.

The content of the nanofiber is not particularly limited, may be appropriately selected depending on the intended purpose, and is preferably 5% by mass or greater relative to the total amount of the helically shaped wing. When the content of the nanofiber is 5% by mass or greater, the effect of improving heat resistance and strength can be obtained.

On the other hand, the content of the nanofiber is preferably 90% by mass or less in total relative to the total amount of the helically shaped wing. In this case, it is possible to prevent difficulty producing the helically shaped wing due to the high content of the nanofiber.

The content of the nanofiber is more preferably 10% by mass or greater but 60% by mass or less in relation with the viscosity of the curable composition constituting the helically shaped wing. In order to better improve the strength of the rotating body, the content of the nanofiber is yet more preferably 20% by mass or greater but 60% by mass or less.

The helically shaped wing of the present disclosure is produced preferably by an additive manufacturing method. Using an additive manufacturing method, it is possible to form complex, minute shapes such as the winglet and the riblet structure integrally.

<2> Hydraulic Micropower Generator

According to another aspect of the present disclosure, a hydraulic micropower generator including the helically shaped wing described above is provided. The hydraulic micropower generator includes the helically shaped wing of the present disclosure, a water conveyance unit configured to convey water to the helically shaped wing, and a power generating unit coupled to the helically shaped wing, preferably includes a foreign matter separating unit, a foreign matter collecting unit, a foreign matter decomposing unit, and an abnormality notifying unit, and further includes other units as needed.

The water conveyance unit is a unit configured to support a water turbine with a turbine shaft in a manner that the water turbine may rotate by the hydraulic power of a water current, and is a unit formed of a metal or a resin and disposed in the waterway.

The metal is not particularly limited and may be appropriately selected depending on the intended purpose. Examples of the metal include stainless steel, titanium, nickel alloys, carbon steel, chromium steel, and manganese steel.

The resin is not particularly limited and may be appropriately selected depending on the intended purpose. Examples of the resin include polyether ether ketone (PEEK) resins, Teflon (registered trademark), MC nylon resins, ultrahigh-molecular-weight polyethylene resins, polyacetal resins, polystyrene resins, styrene-acrylonitrile copolymers, styrene-butadiene copolymers, styrene-maleic anhydride copolymers, polyester resins, polyvinyl chloride resins, vinyl chloride-vinyl acetate copolymers, polyvinyl acetate resins, polyvinylidene chloride resins, polyallylate resins, phenoxy resins, polycarbonate resins, polyvinyl butyral resins, polyvinyl formal resins, polyvinyl toluene resins, poly-N-vinyl carbazole, acrylic resins, silicone resins, epoxy resins, melamine resins, urethane resins, phenol resins, and alkyd resins. One of these resins may be used alone or two or more of these resins may be used in combination.

For example, the shape, size, and structure of the water conveyance unit are not particularly limited and may be appropriately selected depending on the intended purpose so long as the water conveyance unit can convey water to the helically shaped wing of the water turbine.

The power generating unit is not particularly limited so long as the power generating unit can convert the rotational kinetic energy of the helically shaped wing of the water turbine to electric energy. The power generating unit may be either of an alternating-current generator and a direct-current generator, and may be appropriately selected depending on the intended purpose. Examples of the power generating unit include a rotating magnet alternating-current generator, a direct-current generator with a commutator, and a magnet pump.

The rotating magnet alternating-current generator is not particularly limited. For example, a dynamo used in the illumination device of a bicycle can be used.

In the magnet pump, a driven magnet included in a rotor rotates synchronously with rotation of a driving magnet magnetically coupled to the driven magnet and can suction and pneumatically transport a fluid. By the magnetic force, the rotating magnets can rotate interlockingly with rotation of the helically shaped wing. The rotating magnets and the helically shaped wing are disposed separately from each other and have no water communication. The magnet pump does not use a shaft seal such as a mechanical seal. Therefore, even through a long time of use, the pump will not be corroded or contaminated, and will be protected from water leakage due to deterioration of the mechanical seal.

In the hydraulic micropower generator, it is preferable that a foreign matter separating unit configured to separate a foreign matter in a liquid be provided on the water conveyance unit. When the foreign matter separating unit is provided on the water conveyance unit, it is possible to separate a foreign matter from water to be conveyed to the water turbine, prevent the helically shaped wing from being broken, and generate power efficiently for a long term.

For example, the size, shape, structure, and material of the foreign matter separating unit are not particularly limited and may be appropriately selected depending on the intended purpose.

Examples of the foreign matter separating unit include, a net, a screen, and a filter.

It is preferable that the hydraulic micropower generator include a foreign matter collecting unit configured to collect a foreign matter in a liquid.

It is preferable that the hydraulic micropower generator include a foreign matter decomposing unit configured to decompose a foreign matter collected by the foreign matter collecting unit.

For example, the size, shape, structure, and material of the foreign matter decomposing unit are not particularly limited and may be appropriately selected depending on the intended purpose.

The foreign matter decomposing unit is different depending on the kinds of foreign matters and may be appropriately selected. Examples of the foreign matter decomposing unit include a microbubble generating device, an ultraviolet (UV) irradiator, and a filtration filter having an average pore diameter of 0.1 micrometers or less.

It is preferable that the hydraulic micropower generator include an abnormality notifying unit configured to notify occurrence of abnormality. Examples of abnormality include maloperation and operation failure of the hydraulic micropower generator, clogging of a flow path, and reduction of the water volume in the waterway.

Examples of the abnormality notifying unit include displays, mailing, speakers, lights, and portable device applications utilizing Wi-Fi (registered trademark).

Examples of the other units include a control unit and a power storage unit.

The control unit is a unit configured to control the operation of the hydraulic micropower generator of the present disclosure. The control unit may include memory units such as a read only memory (ROM) and a random access memory (RAM), and computing units such as a central processing unit (CPU) and a field programmable gate array (FPGA). The memory unit may store a program causing the water turbine and the water conveyance unit to perform specific operations. The control unit controls the operations of each unit based on the program.

The power storage unit is a unit configured to store the power generated by the hydraulic micropower generator. Examples of the power storage unit include lithium ion secondary batteries, nickel-cadmium batteries, and lead-acid batteries.

The hydraulic micropower generator of the present disclosure can be introduced into a small water channel into which it hitherto has been difficult to introduce one, and can accommodate to a small hydraulic head and a low flow rate. The hydraulic micropower generator of the present disclosure can be installed at, for example, rivers, agricultural water, agricultural water channels, industrial water, drainage channels of, for example, plants, buildings, and sewage plants, and headraces in plants.

### EXAMPLES

The present disclosure will be described in detail below by way of Examples. The present disclosure should not be construed as being limited to these Examples.

### Example 1. Production of Helically Shaped Wing

Using a thermoplastic resin (PA12, obtained from Hewlett Packard (HP Inc.), helically shaped wings 1 to 10 having the shape described below were produced by a high speed sintering (HSS) method.

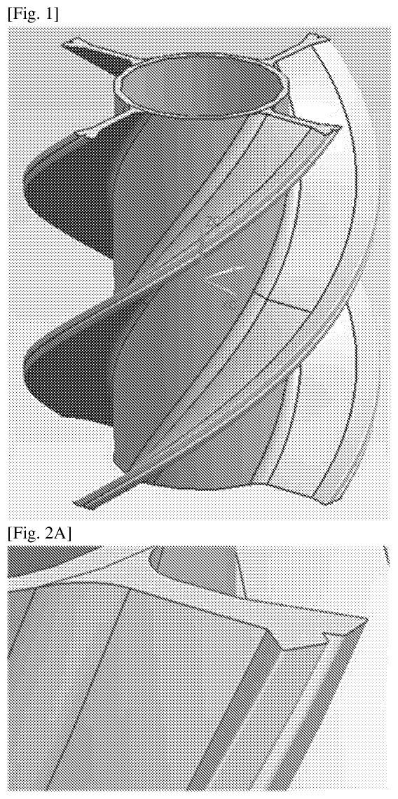

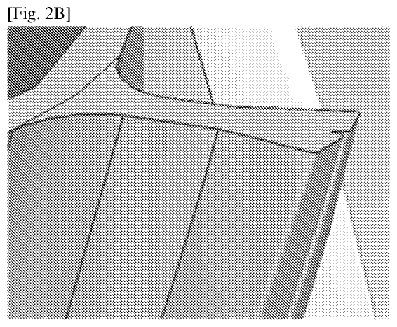

FIG. 1 is an exemplary view of the helically shaped wing No. 4 in Example 1. FIG. 2A is a partial expanded view illustrating a winglet shape 1 in Example 1. FIG. 2B is a partial expanded view illustrating a winglet shape 2.

A blade pitch means the helical pitch of blades. A pitch of 1 is a pitch at which exactly one lap is made around the shaft portion from the upper end thereof to the lower end thereof. A number of blades is the number of blade portions attached on one shaft portion. A number of 3 means that three helical blade portions are attached. A blade width is expressed as a relative value to the helically shaped wing No. 1 serving as a reference. Both winglet shapes represent bifurcated winglets. However, in the shape 1, the winglet to which a fluid pressure is applied has an inclination angle of 30 degrees and another winglet to which no fluid pressure is applied has an inclination angle of 11 degrees, whereas in the shape 2, both of the winglets have an inclination angle of 11 degrees.

TABLE 1

| | Blade | Number of | Blade | Blade | Riblet |
|---|---|---|---|---|---|
| No. | pitch | blades | shape | width | structure |
| 1 | 0.5 | 3 | No | 1 | Absent |
| | | | winglet | | |
| 2 | 0.5 | 4 | Winglet 1 | ⅔ | Absent |
| 3 | 0.5 | 5 | Winglet 2 | ½ | Absent |
| 4 | 1 | 3 | Winglet 1 | ½ | Absent |
| 5 | 1 | 4 | Winglet 2 | 1 | Absent |
| 6 | 1 | 5 | No | ⅔ | Absent |
| | | | winglet | | |
| 7 | 1.5 | 3 | Winglet 2 | ⅔ | Absent |
| 8 | 1.5 | 4 | No | ½ | Absent |
| | | | winglet | | |
| 9 | 1.5 | 6 | Winglet 1 | 1 | Absent |
| 10 | 1 | 5 | Winglet 1 | 1 | Present |

### Example 2. Performance Test

Using the helically shaped wings described above, the rotation torque of the blades to the flow rate was measured. As a result, it turned out that the torque was higher when the blade pitch was narrower, the blade width was greater, the winglets had the shape 1, and the number of blades was greater. Particularly, it turned out that the torque obtained when winglets were provided was higher than the torque obtained when no winglets were provided, and that depending also on the shape of the winglets, a high efficiency was obtained when the winglet to which the fluid pressure was applied had a greater inclination. The torque obtained when a shark skin-like riblet structure was formed was higher than the torque obtained when no riblet structure was formed.

Aspects of the present disclosure are, for example, as follows.

<1> A helically shaped wing including:
a column-shaped shaft portion;
a blade portion disposed helically on a side surface of the shaft portion; and
a winglet on an end portion of the blade portion.

<2> The helically shaped wing according to <1>,
wherein a width of the blade portion is from five times through a hundred times greater than a width of the winglet.

<3> The helically shaped wing according to <1> or <2>,
wherein an inclination angle of the winglet with respect to the blade portion is from 5 degrees through 80 degrees.

<4> The helically shaped wing according to any one of <1> to <3>,
wherein the winglet has a shape obtained by bifurcating the end portion of the blade portion.

<5> The helically shaped wing according to <4>,
wherein an inclination angle of one of winglets of the winglet obtained by bifurcating with respect to a curved surface of the blade portion is from one time through eight times greater than an inclination angle of another one of the winglets with respect to the curved surface of the blade portion.

<6> The helically shaped wing according to any one of <1> to <5>,
wherein the shaft portion or the blade portion, or both have a riblet structure.

<7> The helically shaped wing according to <6>,
wherein the riblet structure has a recessed and bumped shape including recesses and bumps continuous in a predetermined pattern.

<8> The helically shaped wing according to <7>,
wherein the recessed and bumped shape of the riblet structure is a cyclically U-shape or V-shape-grooved structure.

<9> The helically shaped wing according to <7>,
wherein the recessed and bumped shape of the riblet structure is a shape of a cyclic square wave or sinusoidal wave.

<10> The helically shaped wing according to any one of <7> to <9>,
wherein a difference between a maximum height and a minimum height of the recessed and bumped shape is from 50 micrometers through 2 mm.

<11> A hydraulic micropower generator including
the helically shaped wing according to any one of <1> to <10>.

The helically shaped wing according to any one of <1> to <10> and the hydraulic micropower generator according to <11> can solve the various problems in the related art and achieve the object of the present disclosure.

1. A helically shaped wing comprising:
a column-shaped shaft portion;
a blade portion disposed helically on a side surface of the shaft portion; and
a winglet on an end portion of the blade portion.

2. The helically shaped wing according to claim 1,
wherein a width of the blade portion is from five times through a hundred times greater than a width of the winglet.

3. The helically shaped wing according to claim 1,
wherein an inclination angle of the winglet with respect to the blade portion is from 5 degrees through 80 degrees.

4. The helically shaped wing according to claim 1,
wherein the winglet has a shape obtained by bifurcating the end portion of the blade portion.

5. The helically shaped wing according to claim 4,
wherein an inclination angle of one of winglets of the winglet obtained by bifurcating with respect to a curved surface of the blade portion is from one time through eight times greater than an inclination angle of another one of the winglets with respect to the curved surface of the blade portion.

6. The helically shaped wing according to claim 1,
wherein the shaft portion or the blade portion, or both have a riblet structure.

7. The helically shaped wing according to claim 6,
wherein the riblet structure has a recessed and bumped shape including recesses and bumps continuous in a predetermined pattern.

8. The helically shaped wing according to claim 7,
wherein the recessed and bumped shape of the riblet structure is a cyclically U-shape- or V-shape-grooved structure.

9. The helically shaped wing according to claim 7,
wherein the recessed and bumped shape of the riblet structure is a shape of a cyclic square wave or sinusoidal wave.

10. The helically shaped wing according to claim 7,
wherein a difference between a maximum height and a minimum height of the recessed and bumped shape is from 50 micrometers through 2 mm.

11. A hydraulic micropower generator comprising the helically shaped wing according to claim 1.
